(19) United States
(12) Patent Application Publication
(10) Pub. No.: US 2004/0250896 A1
(43) Pub. Date: Dec. 16, 2004

(54) Wood plug trimmer guide

(76) Inventors: Dean W. Hess, Ottawa, IL (US); Charles J. Hess, Ottawa, IL (US)

Correspondence Address: John P. Cooney, 119 East Butterfield Road, North Aurora, IL, 60542, US

(21) Appl. No.: 10/440,722

(22) Filed: May 16, 2003

(51) Int. Cl. B27C 5/00

(52) U.S. Cl. 144/218

(57) ABSTRACT

The wood plug trimmer is a devise used in conjunction with a hand held grinder that permits expeditious trimming of wooden plugs that are used to cover screws in wooden objects. The wood plug trimmer will have an interior cylindrical shape that will slide over the shank of a hand held grinder. The interior diameter of the wood plug trimmer will be slightly smaller than the exterior diameter of the shank of the hand held grinder and slightly shorter in length than the length of the base of the shank of the hand held grinder to the tip of the grinding die. This will permit the wood plug trimmer to be adjusted so that the grinding die will be flush with the wood surface. The wood plug trimmer will have a plurality of pilot/waste ports that will be wider than the wooden plugs to be trimmed. When in place the wood plug trimmer will have the wood plugs pass through the pilot/waste ports and permit the grinding die to trim the wooden plug flush with the surface. This will eliminate the need for hand tools and expeditiously and safely permit the removal of the excess wood plugs.

### CROSS-REFERENCE TO RELATED APPLICATIONS

None.

### TECHNICAL FIELD

The invention relates generally to the trimming of wood plugs that are used in carpentry for the construction of furniture and cabinets and the like that are assembled utilizing a hand held grinder.

### BACKGROUND ART

Carpenters utilize wood plugs to cover screws in assembled furniture. After a piece of furniture is created the wood plug is glued into a countersunk hole in order to cover the screw head. The wood plug is generally inserted so that it extends past the wood surface of the furniture's surface. The shape and diameter of the plugs vary and the location of the plugs can be in difficult to reach areas, i.e. joints or corners. Presently carpenters and furniture builders utilize handsaws to trim the plugs down and then to sand the area so that they are flush with the wood surfaces. This process is labor intensive and great care has to be taken so as not to mar the wood surface. The present art does not disclose any devises that can be used to trim wood plugs on assembled wood furniture or cabinets, in particularly those plugs located in areas that abut other surface that form an angle. The present invention is utilized with hand held grinders that are portable and can fit into tight places on furniture.

### OBJECTS OF THE INVENTION

One object of the invention is to provide a devise to easily trim wood plugs that are used in filling of countersunk screw holes created in the construction of wood furniture and cabinets that will also protect against injuring or scaring the surface of the wood product. Another object of the invention is to provide a hand held devise that will permit easy access to areas that cannot otherwise be reached by other plug trimming devises. Another object of the invention is to fulfill the need in the furniture industry for a hand held devise that would trim wooden plugs flush without marring the wood surface.

### DISCLOSURE OF THE INVENTION

A wood plug trimmer, in accord with the invention, comprising a cylindrical element of a fixed diameter and length to attach to a hand held grinder. The length and the diameter of the cylindrical element will be dependent upon the size circumference and depth of the shank area of a particular hand held grinder it is to be used in conjunction with. The interior circumference of the cylindrical element will be of slightly smaller diameter than the outer circumference of the shank of the hand held grinder. The length of the cylindrical element will be slightly shorter than length of the end of the base of the shank to the end of the grinding die attached thereto. The cylindrical element will be cut along the length of the cylindrical element so that it will permit the cylindrical element to expand to slide over the shank. The bottom end will of the cylindrical element fit around the shank and will have a means to secure the element to the shank so that the cylindrical element will extend from the hand held grinder at a plurality of positions. The end of the cylindrical element that is opposite to the hand held grinder will have two or more openings that will act as pilot guides in order to move over the wood plugs and waste disposal ports for the wood material trimmed from the plugs. The wood plugs will be able to pass through the pilot/waste ports and the waste material created from the removal of the wood plug will come out the ports. Each of the openings will be large enough to permit the wood plug to go through them. The distance the element shall extend from the die hand held grinder will be able to be adjusted so that the grinding end of the die hand held grinder will run flush against the wood surface so that the wood plug will be cut down to the wood surface. (Claim 1)

In accord with one aspect of the invention, the cylindrical element will be held in place on the die hand held grinder by a fastener element that will fit around the exterior of the cylindrical element and hold the cylindrical element in place. (Claim 2)

In accord with one aspect of the invention, the fastener element will be a hose clamp. (Claim 3)

In accord with one aspect of the invention, the fastener element will be a ring spring fastener. (Claim 4)

In accord with one aspect of the invention, the fastener element will be cable ties. (Claim 5)

Preferably the cylindrical element will be manufactured using PVC tube (Claim 6).

In accord with one aspect of the invention, the cylindrical element will be manufactured using polymer. (Claim 7)

In accord with one aspect of the invention, the cylindrical element will be manufactured out of wood (Claim 8)

In accord with one aspect of the invention, the cylindrical element will be manufactured out of metal (Claim 9).

### BRIEF DESCRIPTION OF THE DRAWINGS

FIG. 1 is a perspective view of the first embodiment of the invention showing the application of the invention to a hand held grinder on a wood surface with wooden plugs in place by means of attachment being in this figure a hose clamp. This Figure shows how the pilot/waste ports will permit the devise to pass over the wooden plugs allowing the die grinder to grind them flush with the wood surface.

FIG. 2 is a perspective view of the invention showing the dimensions of the invention that is referred to in the claims and drawings.

FIG. 3 is a perspective view the details of the cylindrical element of the invention, which shows the linear cut and the waste ports.

FIG. 4 is an expanded view of the invention as it relates to the positioning of the invention over the shank of the hand held grinder and through the hose clamp fastener.

FIG. 5 is a view of the invention from the bottom with the invention over the hand held grinder's shank and held in place by means of a hose clamp.

FIG. 6 is a profile view of the invention utilizing the hose clamp fastener on the grinder as it relates to being place on a wood surface and the die grinder end being adjusted to be flush with the wood surface.

FIG. 7 is a perspective view of the invention utilizing a ring spring fastener as a means of attachment.

FIG. 8 is a perspective view of the invention utilizing cable ties as a means of attachment.

### DETAILED DISCLOSURE OF INVENTION

Referring to the drawings, FIG. 1 illustrates the wood plug trimmer's cylindrical element (1) as it is in place on a hand held grinder (4) and attached thereto utilizing a hose clamp element as a means of attachment (3). The cylindrical element (1) has pilot/waste port elements (2) located at the end of the wood plug trimmer that comes in contact with the wood surface and are wide enough to permit the wooden plugs that are to be trimmed to pass through the pilot/waste port elements (2). The cylindrical element (2) is of a slightly shorter length than the grinding end of the hand held grinder's shank element's (9) base to the end of the grinding die element (8), so that it can be adjusted to permit the grinding die element (8) to be flush with the wood surface so the wooden plugs that it grinds will be flush with the wood surface.

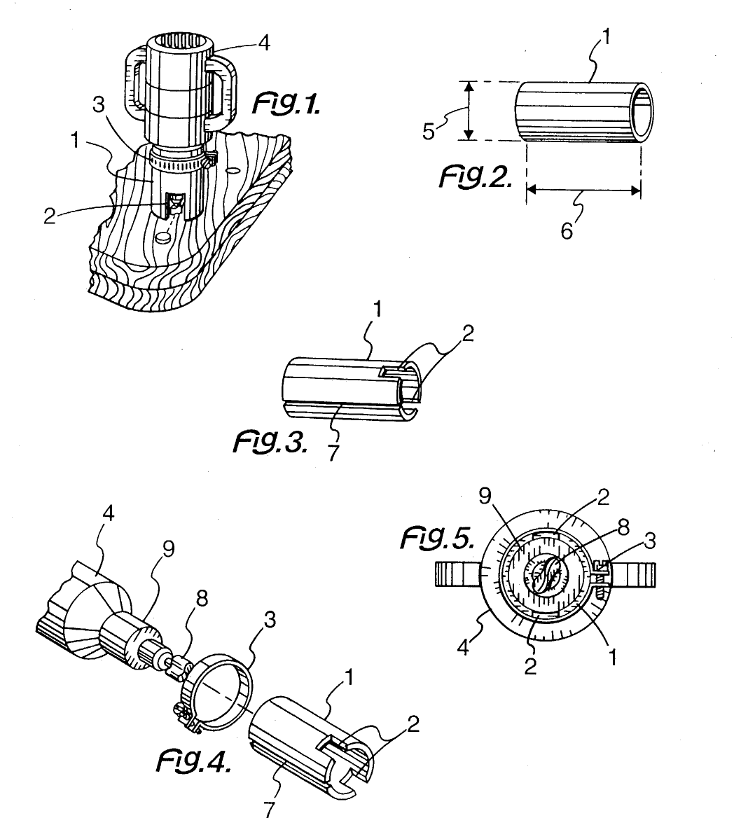

FIG. 2 shows the dimensional view of the invention showing the inner dimension (5) and the length (6).

FIG. 3 shows a profile of the invention. FIG. 2 shows the linear cut (7) in the cylindrical element (1). FIG. 2 further shows the pilot/waste port elements (2)

FIG. 4 shows an exploded view of the invention as it relates to the hand held grinder (4). The cylindrical element (1) will be placed over the shank element (9) of the hand held grinder (4) thus permitting the grinding die element (8) to extend to the wood surface at the opposite end of the cylindrical element (1) and will be held in place by a means of attachment this being a hose clamp fastener element (3).

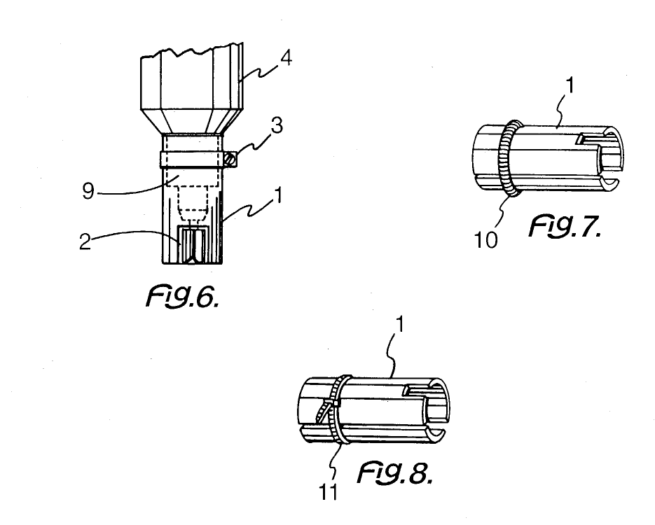

FIG. 5 shows a bottom view of the invention that is in place on the grinder (4). FIG. 5 shows the cylindrical element (1) with two pilot/waste port elements (2) and attached by a hose clamp element being the means of attachment (3). The cylindrical element is placed over the shank element (9) and the grinding die element (8) is located in the center of the cylindrical element (1) so that the pilot/waste port elements (2) will permit the wooden plugs to pass through them and come in contact with the grinding die element (8) and be ground flush with the wood surface.

FIG. 6 shows a profile view of the invention with a shadow of the shank element on a wooden surface. FIG. 6 shows the cylindrical element (1) placed over the shank element (9) and held in place by a hose clamp element as the means of attachment (3). FIG. 6 further shows the grinding die element (8) extending to the most outward point of the cylindrical element (1) as seen through the pilot/waste port elements (2) so that the end of the cylindrical element in contact with the wood surface shall extend from the hand held grinder (4) so the grinding die element (8) is flush with the wood surface.

FIG. 7 shows a profile view of the invention that utilized as the means of attachment being a ring spring fastener element (10).

FIG. 8 shows a profile view of the invention that utilized as the means of attachment being a cable tie element (11).

1. A wood plug trimmer comprising of:
a cylindrical element of a inner diameter slightly less than the exterior diameter of the grinder's shank element that is used with the wood plug trimmer and shorter than the total length of the area extending from the base of the grinder's shank element to the end of the grinding die element of the grinder that is used with the wood plug trimmer;
said cylindrical element shall have a linear cut that runs the entire length of the cylindrical element;
said cylindrical element shall have a plurality of pilot/waster port elements on the end of the cylindrical element that will come in contact with the wood surface and the pilot/waste port elements shall be wide enough to permit the wooden plugs that are to be trimmed to pass through the pilot/waste port elements.

2. The wood plug trimmer as described in claim 1 wherein the cylindrical element is held in place on the shank of the hand held grinder by a means of attachment.

3. The wood plug trimmer as described in claim 2 wherein the means of attachment is a hose clamp fastener.

4. The wood plug trimmer as described in claim 2 wherein the means of attachment is a ring spring fastener.

5. The wood plug trimmer as described in claim 2 wherein the means of attachment is a cable tie.

6. The wood plug trimmer as described in claim 1 wherein the cylindrical element is manufactured using a PVC tube.

7. The wood plug trimmer described in claim 1 wherein the cylindrical element is manufactured using a polymer.

8. The wood plug trimmer described in claim 1 wherein the cylindrical element is manufactured out of wood.

9. The wood plug trimmer described in claim 1 wherein the cylindrical element is manufactured out of metal.
